(19) United States
(12) Patent Application Publication
(10) Pub. No.: US 2002/0147027 A1
(43) Pub. Date: Oct. 10, 2002

(54) System and method for configuring managed computers using an electronic mobile handheld device

(75) Inventors: Jack A. Alford JR., Austin, TX (US); Kenneth R. Banning, Austin, TX (US); James L. Lentz, Austin, TX (US)

Correspondence Address: Edmond A. DeFrank, 19803 Ahwanee Lane, Northridge, CA, 91326, US

(73) Assignee: International Business Machines Corporation, Armonk, NY

(21) Appl. No.: 09/826,705

(22) Filed: Apr. 5, 2001

(51) Int. Cl. H04M 1/00

(52) U.S. Cl. 455/557; 455/556; 455/418; 455/420

(57) ABSTRACT

The present invention is embodied in a system and method for configuring computers using an electronic mobile handheld device, such as a personal digital assistant (PDA). Specifically, the electronic mobile handheld device is used as a data transfer mechanism and special handwriting codes, popup software keyboards, or other methods that are not intuitive to users that are error-prone are not required. In general, the present invention includes an electronic mobile handheld device, a first computer system containing a configuration profile or configuration parameters and N computer systems that requires configuration with the profile or configuration parameters. The electronic mobile handheld device can be any suitable portable electronic device, such as a wireless telephone, personal digital assistant, portable notebook computer or the like.

### BACKGROUND OF THE INVENTION

1. Field of the Invention.

The present invention relates in general to electronic mobile handheld devices and computer systems and in particular to a system and method for configuring computers using an electronic mobile handheld device, such as a handheld computer or a personal digital assistant.

2. Related Art.

Electronic computer based mobile devices are becoming more and more ubiquitous because they help users manage their busy schedules, as well as communicate with the world. For example, portable computers, such as notebook or laptop computers, personal digital assistants (PDAs) and mobile telephones are becoming necessities for many. Notebook or laptop computers are very popular because they are extremely lightweight personal computers that can easily fit in a briefcase for the mobile businessperson. Aside from size, the principal difference between a notebook or laptop computer and a personal computer is the display screen. Portable computers typically use flat-panel technologies, which are lightweight and non-bulky.

A PDA is a handheld mobile device or handheld computer that allows users to access information, keep track of their busy schedules, and communicate with others. It is very important for today's mobile professional to be able to access information from anywhere in the world. Similar to the portable computer, PDAs are very popular because they are designed to be portable and small. Currently, PDA manufactures strive to make PDAs as portable and small as possible. Fitting easily into a wallet, small purse, or shirt pocket, the newest PDAs can travel anywhere in the world. Therefore, people do not think twice about taking their portable computer, PDA or mobile telephone anywhere.

Further, since PDA devices are becoming more and more popular, they are being built with more memory, more computing power and greater compatibility with personal computers than previous generation of PDAs. As such, PDAs are becoming the portable devices of choice by business professionals. However, limited uses are available that combine the power and portability of the PDA with the power and compatibility of a personal computer. Instead, PDAs and related mobile devices are primarily used for contact and time management synchronization with the personal computer.

As the Internet becomes more and more popular, it becomes increasingly common for Internet Service Providers (ISPs) and Application Service Providers (ASPs) to install multiple server computers in racks, and for these rack-mounted systems to be purchased and installed without keyboards or displays attached to each individual computer. At a minimum, TCP/IP addresses or other networking parameters needed to define the computer on the network must be correctly entered, after which the server computer can be managed by a remote console which communicates with the managed computer via a network connection.

Some available systems use configuration terminals that are rolled up on a cart to the managed computer or server. The configuration terminal is connected to each server in turn and configuration data is extracted. Other systems use PDAs to act as a connected data-entry device for supporting initial configuration of the rack-mounted servers. Namely, the PDAs are plugged into the same serial port used by a normal terminal. These systems establish a terminal emulation session with the server, allowing commands to be entered from the PDA. Although terminal emulation software is used, it still requires the user to use special handwriting codes. Yet other systems offer a PDA-based program that lets the user plug the PDA into the serial port, but uses a web-browser-like user interface to simplify the configuration process somewhat. However, this still requires the use of special handwriting codes.

Thus, the PDA solutions still require the user to perform the initial data entry on the PDA while connected to the managed computer. These methods use special handwriting codes, popup software keyboards, or other methods that are not intuitive to users, are error-prone, and are slow compared to typing on a keyboard or using the graphical user interfaces common to personal computers. As such, current techniques do not use a familiar user interface, which can be time consuming and unreliable.

Therefore, what is needed is a system and method for configuring computers using a familiar user interface, such as those found on personal computers. In such a system, a handheld device, such as a personal digital assistant, serves primarily as a data transfer mechanism, rather than providing the primary user interface for configuration. What is further needed is a system and method that uses a first computer, such as a personal computer, which is not being configured, to provide a familiar user interface, error checking, help information, and any other conveniences to the user while the configuration profile for the computer to be configured is prepared. What is additionally needed is a system with a first computer that holds model configuration profiles, or copies of previously-created profiles, that the user can copy and modify for each computer that must be configured without requiring special handwriting codes, popup software keyboards, or other methods that are not intuitive to users.

### SUMMARY OF THE INVENTION

To overcome the limitations in the prior art described above, and to overcome other limitations that will become apparent upon reading and understanding the present specification, the present invention is embodied in a system and method for configuring computers using electronic mobile handheld devices, such as a handheld computer or personal digital assistant (PDA). Specifically, the electronic mobile handheld device is used as a data transfer mechanism and special handwriting codes, popup software keyboards, or other methods that are not intuitive to users or that are error-prone are not required.

In general, the present invention includes a mobile electronic device, a first computer system containing a configuration profile or configuration parameters, and N computer systems that require configuration with the profile or configuration parameters. The electronic mobile device can be any suitable portable electronic device, such as a wireless telephone, personal digital assistant, portable notebook computer or the like capable of storing the configuration data, and capable of connecting to a standard port on the computer.

In particular, first, basic configuration is initiated by prompting the user to enter configuration information or a configuration profile on the first computer. The first computer is preferably a personal computer, which is not being configured, that provides a familiar user interface, error checking, help information, and any other conveniences to the user while the configuration profile for the computer to be configured is prepared. Second, the configuration information is transferred into an electronic mobile handheld device, via a standard cable connection or a wireless connection and then appropriately stored within the memory of the electronic mobile handheld device.

Last, the configuration information is transferred from the electronic mobile handheld device into the computer (N computers can be configured) being configured, via a standard cable connection or a wireless connection. The computers can have similar configuration profiles, however, it's not likely that the all the N computers that are to be configured would have the same configuration profiles. The most likely configuration information to be entered is the unique IP address and hostname for the computer. As such, it should be noted that while there usually is a unique profile for each computer to be configured, they can all have similar profiles, but usually will contain some unique information.

An advantage of the present invention is that it allows the user to create configuration profiles using a familiar personal computer interface and to configure other computers with a familiar electronic mobile handheld device. Namely, the user can stand in front of a rack of computers and simply connect the electronic mobile handheld device into one of the computers and transfer all configuration information into the computer to be configured with a single point-and-click operation. In addition, if more than one computer requires configuration, the user can simply connect the electronic mobile handheld device to the next computer and repeat the process using a similar configuration profile that is stored in the electronic mobile handheld device.

The present invention as well as a more complete understanding thereof will be made apparent from a study of the following detailed description of the invention in connection with the accompanying drawings and appended claims.

### BRIEF DESCRIPTION OF THE DRAWINGS

Referring now to the drawings in which like reference numbers represent corresponding parts throughout:

FIG. 1 is a general block diagram showing an exemplary overview of the present invention.

FIG. 2 is a block diagram illustrating the components of the present invention.

FIG. 3 is a flow chart illustrating operational details of the present invention.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. Introduction and Exemplary Operating Environment

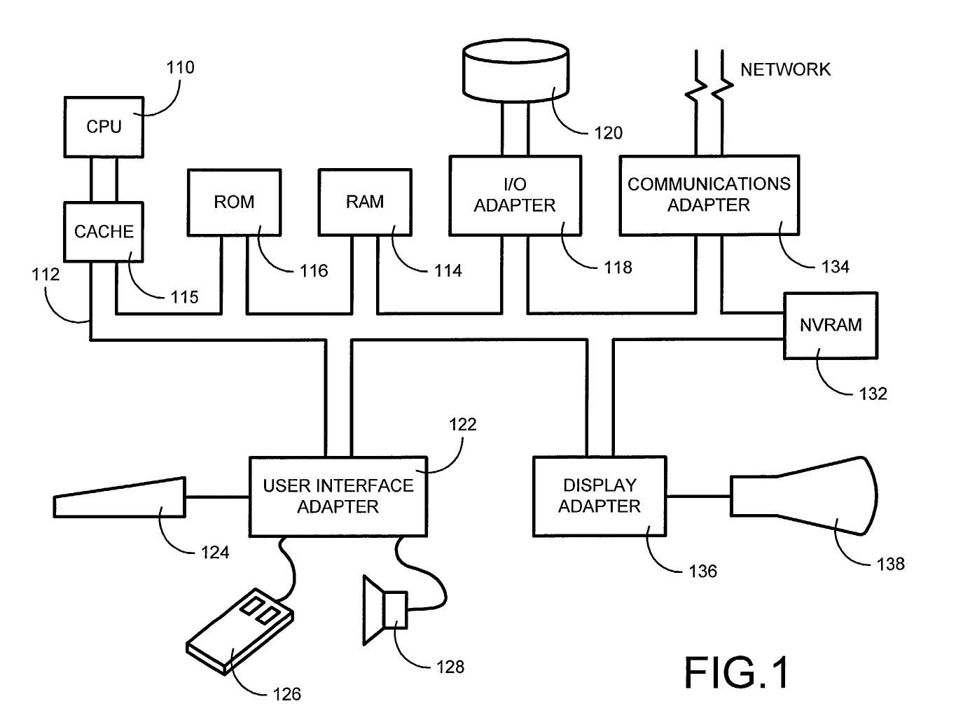

The preferred embodiments may be practiced in any suitable hardware configuration, such as computing system 100 illustrated in FIG. 1 or, alternatively, in a laptop or notepad computing system. Computing system 100 includes any suitable central processing unit 110, such as a standard microprocessor, and any number of other objects interconnected via system bus 112. For purposes of illustration, computing system 100 includes memory, such as read only memory (ROM) 116, random access memory (RAM) 114, and peripheral memory devices (e.g., disk or tape drives 120) connected to system bus 112 via I/O adapter 118. Computing system 100 further includes a display adapter 136 for connecting system bus 112 to a conventional display device 138. Also, user interface adapter 122 could connect system bus 112 to other user controls, such as keyboard 124, speaker 128, mouse 126, and a touchpad (not shown).

One skilled in the art readily recognizes how conventional computers and computer programs operate, how conventional input device drivers communicate with an operating system, and how a user conventionally utilizes a input devices to initiate the manipulation of objects in a graphical user interface.

A graphical user interface (GUI) and operating system (OS) of the preferred embodiment reside within a computer-readable media and contain device drivers that allows one or more users to initiate the manipulation of displayed object icons and text on a display device. Any suitable computer-readable media may retain the GUI and operating system, such as ROM 116, RAM 114, disk and/or tape drive 120 (e.g., magnetic diskette, magnetic tape, CD-ROM, optical disk, or other suitable storage media).

In the preferred embodiments, the COSE.TM. (Common Operating System Environment) or Common Desktop Environment (CDE) desktop GUI interfaces the user to the AIX. TM. operating system. The GUI may be viewed as being incorporated and embedded within the operating system. Alternatively, any suitable operating system or desktop environment could be utilized. Examples of other GUIs and/or operating systems include X11.TM. (X Windows) graphical user interface, Sun's Solaris.TM. operating system, and Microsoft's Windows 95/98/2000.TM. operating system. While the GUI and operating system merely instruct and direct CPU 110, for ease in explanation, the GUI and operating system will be described as performing the following features and functions.

II. General Overview of the Components

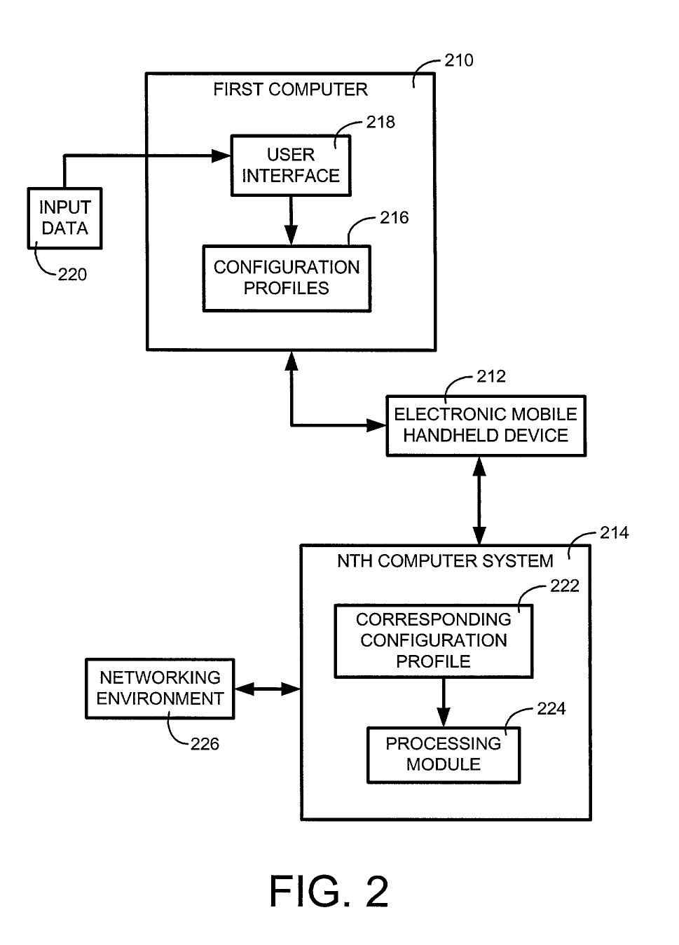

FIG. 2 is a block diagram illustrating the components of the present invention. Referring to FIG. 1 along with FIG. 2, the present invention includes a first computer system 210, an electronic mobile handheld device 212, such as a personal digital assistant (PDA), and N managed computer systems 214 that need to be configured with a configuration profile 216 or configuration parameters. The computer systems 210, 214 can operate in any suitable computer environment for configuring devices. In one computer environment, multiple server computers in racks are N computer systems 214 that are required to be configured.

The electronic mobile handheld device 212 can be any suitable handheld mobile electronic device, such as a notebook, personal digital assistant (PDA), cellular/cordless telephone, or similar miniature device capable of storing the profile and transferring it to the managed computer via common connection ports. The electronic mobile handheld device 212 is interconnected to the first computer system and the N computer systems. In addition, the electronic mobile handheld device 212 can be wirelessly connected to a network via a cellular or wireless modem networking system. The network can be any suitable network, such as a local or intranet system or a wide area network like the Internet. It should be noted that until the IP address, hostname, etc. are defined on the managed computers, the devices are not truly interconnected. Also, the first computer does not have to be network-connected.

The first computer 210 includes configuration software with a graphical user interface 218 to allow quick and easy initiation and specification of the configuration information and creation of individual configuration profiles. This can be accomplished with suitable software installed on the first computer 210. Namely, the software provides a user interface 218 for allowing a user to enter input data 220 in the form of configuration information for configuration of the N computer systems 214. The electronic mobile handheld device is used to upload, store and download the individual configuration profiles so that each respective N computer system has the appropriate configuration profile 222. In addition, each of the N computer systems 214 includes a software module 224 that processes the configuration profile 222 to allow proper operation in a networking environment 226.

III. Details of the Components and Operation

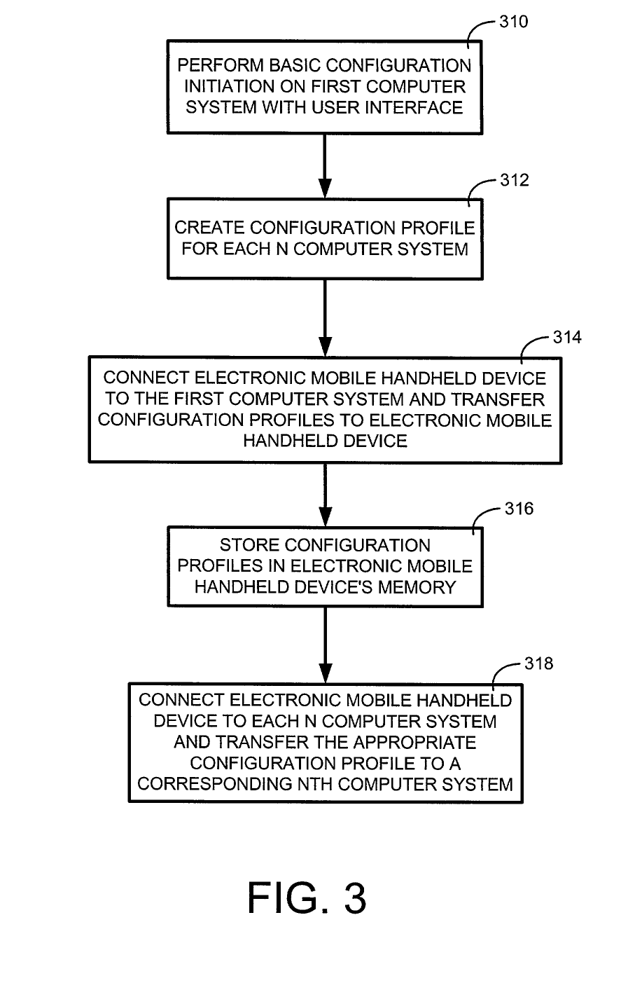

FIG. 3 is a flow chart illustrating operational details of the present invention. Referring to FIGS. 1-2 along with FIG. 3, first, basic configuration initiation is performed on first computer system with user interface 218 (step 310). This involves the user logging into the system. Second, configuration profiles for each N computer system are created with the user interface 218 (step 312). This can be accomplished by having the user interface 218 prompt the user to enter configuration information appropriate for the type of computer system to be configured. For instance, the user interface 218 can prompt the user for TCP/IP addresses on other network parameters needed to define the computer on the network that is to be configured. In addition, configuration information for one or more managed computers can be entered using the user interface 218, then saved as individual configuration profiles 216 on the first computer 210.

The configuration information or each profile 216 created by the user is saved in a standard electronic mobile handheld device database file format on the personal computer. The electronic mobile handheld device database file is then transferred to the electronic mobile handheld device 212 using standard PC-to-electronic mobile handheld device synchronization methods via a standard cable connection or a wireless connection (step 314), and then appropriately stored within the electronic mobile handheld device's 212 memory (step 316). Since the configuration information is now stored in the electronic mobile handheld device 212, it can be carried by the user to the managed N computer systems and appropriately transferred to each managed computer system.

The electronic mobile handheld device is then connected to each N computer systems and the appropriate configuration profile is transferred to a corresponding N computer system (step 318). Specifically, the electronic mobile handheld device 212 is connected to each managed computer system using standard PC-to-electronic mobile handheld device synchronization methods via a standard cable connection or a wireless connection. For example, an electronic mobile handheld device synchronization cable can be connected to a standard serial port on the managed computer. Next, a listener program, or daemon, which is preloaded on the managed computer, is started automatically when the computer is booted.

Typically, the listener program or daemon is part of the base operating system running on the server or managed computer. The daemon establishes contact with the electronic mobile handheld device, and when directed by the user from the electronic mobile handheld device, the daemon transfers the saved configuration information to the particular managed computer. Once the configuration information has been received, the daemon then executes commands on the particular managed computer to save the configuration information in configuration files, or otherwise perform the requested configuration operations.

IV. Conclusion

The present invention allows the user to perform most of the required configuration actions using a familiar graphical user interface and keyboard on a personal computer. Data entry speed and accuracy are improved compared with entering the same data directly on the electronic mobile handheld device. The time that user is required to spend at the computer being configured is only that required to authenticate (by entering the password) and transfer the data. When multiple computers must be configured, the savings in time, and the avoidance of data-entry errors, are multiplied.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for configuring a managed computer system with an electronic mobile handheld device, comprising:
creating at least one configuration profile associated with the managed computer system with a user interface on a first computer;
transferring the configuration profile to the electronic mobile handheld device; and
configuring the managed computer system by connecting the electronic mobile handheld device to the managed computer system and transferring the configuration profile.

2. The method of claim 1, further comprising storing the configuration profile in a file format readable by the electronic mobile handheld device.

3. The method of claim 2, wherein the file format is a database file format.

4. The method of claim 1, wherein the electronic mobile handheld device is a personal digital assistant.

5. The method of claim 1, further comprising using a computer-to-electronic mobile handheld device synchronization to transfer the configuration profile to the electronic mobile handheld device.

6. The method of claim 5, wherein the computer-to-electronic mobile handheld device synchronization is a wireless connection.

7. The method of claim 1, wherein the user interface allows a user to perform at least one of error checking or electronic help assistance.

8. The method of claim 1, wherein the managed computer system includes multiple server computers as rack-mounted systems.

9. The method of claim 1, wherein the configuration profile includes unique Internet address and hostnames for the managed computer system.

10. An electronic configuration system for configuring a managed computer system, comprising:
a user interface of a first computer that allows a user to create at least one configuration profile associated with the managed computer system; and
an electronic mobile handheld device that receives the configuration profile from the user interface, and interconnects with the managed computer system for configuring the managed computer system with the configuration profile.

11. The electronic configuration system of claim 10, wherein the electronic mobile handheld device is a personal digital assistant.

12. The electronic configuration system of claim 10, wherein the electronic mobile handheld device is a cellular telephone.

13. The electronic configuration system of claim 10, further comprising a computer-to-electronic mobile handheld device synchronization device that transfers the configuration profile to the electronic mobile handheld device.

14. The electronic configuration system of claim 13, wherein the computer-to-electronic mobile handheld device synchronization device is a wireless connection.

15. The electronic configuration system of claim 10, wherein the user interface allows the user to perform at least one of error checking or electronic help assistance.

16. The electronic configuration system of claim 10, wherein the managed computer system includes multiple server computers as rack-mounted systems.

17. The electronic configuration system of claim 10, wherein the configuration profile includes unique Internet address and hostnames for the managed computer system.

18. A computer-readable medium having computer-executable instructions for performing a process on a computer, the process comprising:
creating at least one configuration profile associated with a managed computer system with a user interface on a first computer;
transferring the configuration profile to an electronic mobile handheld device; and
configuring the managed computer system by connecting the electronic mobile handheld device to the managed computer system and transferring the configuration profile.

19. The method of claim 18, wherein the electronic mobile handheld device is a personal digital assistant.

20. The method of claim 18, wherein the user interface allows a user to perform at least one of error checking or electronic help assistance.
